(19) United States
(12) Patent Application Publication
(10) Pub. No.: US 2013/0316755 A1
(43) Pub. Date: Nov. 28, 2013

(54) CALL CONTROL APPARATUS, PTT TERMINAL, AND PTT CALL SYSTEM

(71) Applicant: HUAWEI DEVICE CO., LTD., Shenzhen (CN)

(72) Inventor: Jian Wang, Xi'an (CN)

(73) Assignee: Huawei Device Co., Ltd., Shenzhen (CN)

(21) Appl. No.: 13/754,527

(22) Filed: Jan. 30, 2013

(30) Foreign Application Priority Data
May 23, 2012 (CN) 201220233333.5

(51) Int. Cl. H04W 4/10

(52) U.S. Cl. CPC H04W 4/10
USPC 455/518

(57) ABSTRACT

The present utility model discloses a call control apparatus, a PTT terminal, and a PTT call system. The call control apparatus includes: a control button, a processing chip, and a communication module that are electrically connected, where the control button is configured to detect control information, the processing chip is configured to generate, according to the control information that has been detected by the control button, an instruction for obtaining or releasing a call right and send the instruction for obtaining or releasing a call right to the communication module, and the communication module is configured to establish a communication connection with the PTT terminal, and after establishing the communication connection with the PTT terminal, send the received instruction for obtaining or releasing a call right to the PTT terminal, thereby triggering the obtaining or releasing, by the PTT terminal, of a call right.

### CROSS-REFERENCE TO RELATED APPLICATION

This application claims priority to Chinese Patent Application No. 201220233333.5, filed on May 23, 2012, which is hereby incorporated by reference in its entirety.

### TECHNICAL FIELD

The present utility model relates to the field of communications, and in particular, to a call control apparatus, a PTT terminal, and a PTT call system.

### BACKGROUND

For an ordinary mobile phone, after a number of an opposite party is dialed, a call can be connected only when the opposite party answers. However, PTT (Push to talk, push to talk) has an advantage of connecting a call through one key, and has developed into a service for rapid call setup, that is, a PTT service. A PTT call system is formed by more than two terminals that support the PTT service (for example, PTT mobile phones).

A call control method in an existing PTT call system is that a user pushes a call button on a PTT terminal (for example, a PTT mobile phone) to obtain a call right and makes a call, and then releases the call button and releases the call right after the call.

The inventor finds that it is inconvenient for a user to push a call button on a PTT terminal in some scenarios, which causes inconvenience to the user. For example, when a user is driving a car, operating the PTT terminal affects driving safety.

### SUMMARY

Embodiments of the present utility model provide a call control apparatus, a PTT terminal, and a PTT call system, which can facilitate call control performed by a user on the PTT terminal.

To achieve the foregoing objective, the embodiments of the present utility model adopt the following technical solutions:

A call control apparatus is provided, where the call control apparatus is configured to control a PTT terminal in a push to talk PTT call system to obtain or release a call right, the call control apparatus includes: a control button, a processing chip, and a communication module, the control button is electrically connected to the processing chip, and the processing chip is electrically connected to the communication module, and where

the control button is configured to detect control information;

the processing chip is configured to generate, according to the control information that has been detected by the control button, an instruction for obtaining or releasing a call right, and send the instruction for obtaining or releasing a call right to the communication module; and

the communication module is configured to establish a communication connection with the PTT terminal, and after establishing the communication connection with the PTT terminal, send the received instruction for obtaining or releasing a call right to the PTT terminal, thereby triggering the obtaining or releasing, by the PTT terminal, of a call right.

A PTT terminal is provided and includes: a communication module and a control module, where

the communication module is configured to communicate with a call control apparatus, and receive an instruction for obtaining or releasing a call right, where the instruction for obtaining or releasing a call right is sent by the call control apparatus; and

the control module is configured to obtain a call right from a server or release a call right to a server according to the instruction for obtaining or releasing a call right, where the instruction for obtaining or releasing a call right is received by the communication module.

A PTT call system is provided and includes the foregoing call control apparatus and the foregoing PTT terminal.

In the technical solutions provided by the embodiments of the present utility model, after the control button has detected the control information, the processing chip generates, according to the control information that has been detected by the control button, the instruction for obtaining or releasing a call right, and sends the instruction for obtaining or releasing a call right to the PTT terminal through the communication module, thereby triggering the obtaining or releasing, by the PTT terminal, of the call right, which facilitates the call control performed by the user on the PTT terminal.

### BRIEF DESCRIPTION OF DRAWINGS

To describe the technical solutions in the embodiments of the present utility model more clearly, the following briefly introduces accompanying drawings required for describing the embodiments. Apparently, the accompanying drawings in the following description show merely some embodiments of the present utility model, and persons of ordinary skill in the art may further obtain other drawings according to these accompanying drawings without creative efforts.

FIG. 1 is a schematic structural diagram of a call control apparatus according to an embodiment of the present utility model;

FIG. 2 is a schematic structural diagram of a PTT terminal according to an embodiment of the present utility model;

FIG. 3 is a schematic structural diagram of a PTT call system according to an embodiment of the present utility model; and

FIG. 4 is a schematic flow chart showing that a call control apparatus controls a PTT mobile phone to obtain a call right from a server and release a call right to the server according to an embodiment of the present utility model.

### DESCRIPTION OF EMBODIMENTS

To describe the objective, technical solutions and advantages of the present utility model more clearly, the following further describes the embodiments of the present utility model in detail with reference to the accompanying drawings.

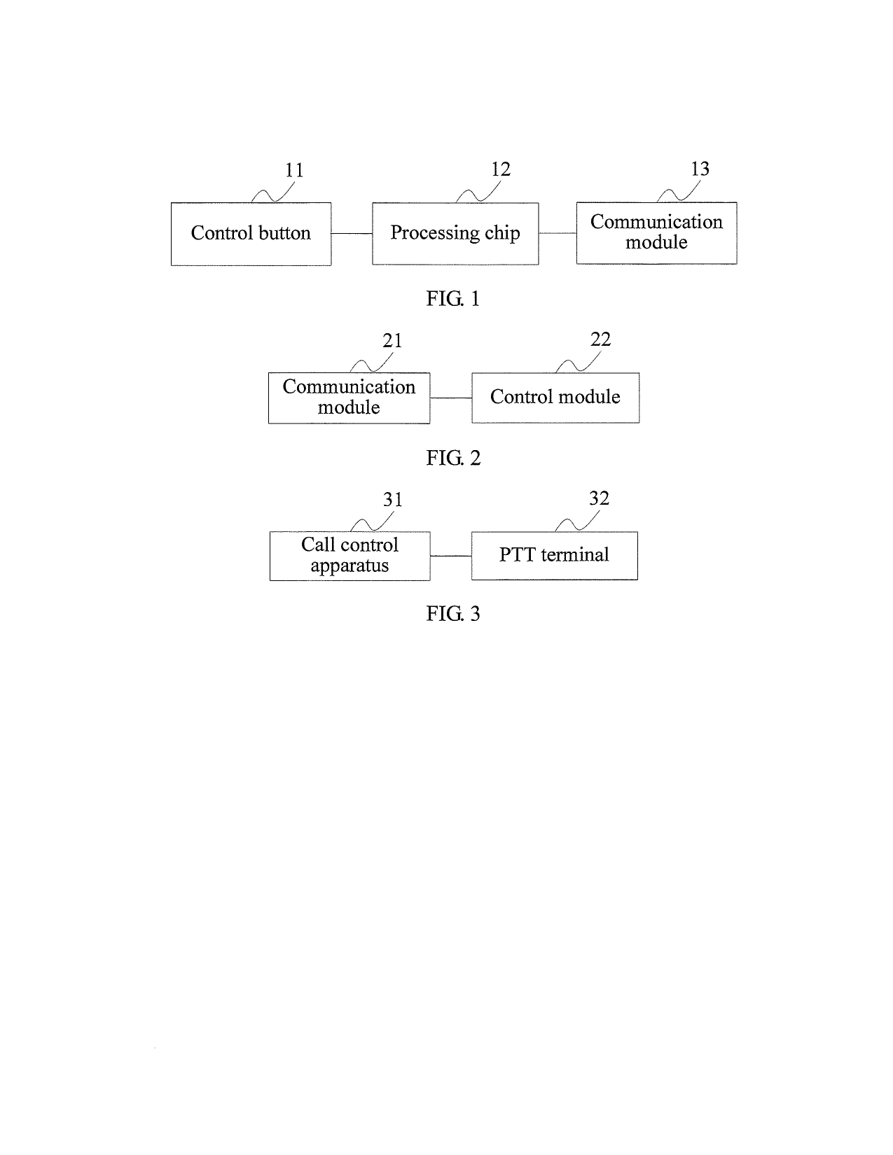

FIG. 1 is a schematic structural diagram of a call control apparatus according to an embodiment of the present utility model. The call control apparatus is configured to control a PTT terminal in a push to talk PTT call system to obtain or release a call right. The call control apparatus includes: a control button 11, a processing chip 12, and a communication module 13, where the control button 11 is electrically connected to the processing chip 12, and the processing chip 12 is electrically connected to the communication module 13, and where

the control button 11 is configured to detect control information;

the processing chip 12 is configured to generate, according to the control information that has been detected by the control button 11, an instruction for obtaining or releasing a call right, and send the instruction for obtaining or releasing a call right to the communication module 13; and

the communication module 13 is configured to establish a communication connection with the PTT terminal, and after establishing the communication connection with the PTT terminal, send the received instruction for obtaining or releasing a call right to the PTT terminal, thereby triggering the obtaining or releasing, by the PTT terminal, of a call right.

The PTT terminal includes, but is not limited to, a mobile phone having a PTT function, and when the communication module 13 communicates with the PTT terminal, a communication manner, such as Bluetooth, may be applied.

After the control button has detected the control information, the processing chip generates, according to the control information that has been detected by the control button, the instruction for obtaining or releasing a call right, and send the instruction for obtaining or releasing a call right to the communication module. The communication module is configured to communicate with the PTT terminal, and send the received instruction for obtaining or releasing a call right to the PTT terminal, thereby triggering the obtaining or releasing, by the PTT terminal, of the call right, which facilitates call control performed by a user on the PTT terminal.

In other embodiments of the present utility model:

Optionally, the communication module may be a Bluetooth device and is configured to communicate with the PPT terminal through Bluetooth.

Optionally, the control button may be positioned on a shell of the call control apparatus and is configured to detect the control information according to a pushed state of the control button.

Optionally, the call control apparatus may also include an indicator light, where the indicator light may be positioned on the shell of the call control apparatus, is connected to the processing chip, and is configured to display, according to a display instruction generated by the processing chip, whether the PTT terminal obtains the call right.

For example, when the PTT terminal controlled by the call control apparatus obtains the call right, a display instruction generating circuit generates a display instruction of the call right being obtained, and the indicator light displays a green color according to the display instruction of the call right being obtained. When the PTT terminal controlled by the call control apparatus does not obtain the call right and after the PTT terminal controlled by the call control apparatus releases the call right, the display instruction generating circuit generates a display instruction of the call right not being obtained, and the indicator light displays a red color according to the display instruction of the call right not being obtained. Definitely, in practice, the indicator light may also display whether the call right is obtained in other forms, which is not limited by the embodiment of the present utility model.

Optionally, the call control apparatus may also include a power input interface, where the power input interface may be positioned on the shell of the call control apparatus, and is configured to receive external power supply. Alternatively, the call control apparatus may also include an internal power supply module, configured to provide electric energy.

Optionally, the call control apparatus may also include a voice module, where the voice module may be configured to collect voice information of the user, send the collected voice information to the PTT terminal through the communication module, and synchronously output voice information received by the PTT terminal from the system.

For example, the voice module may include a microphone device, configured to collect the voice information of the user of the call control apparatus and synchronously output the voice information received by the PTT terminal. Specifically, after the PTT terminal obtains the call right, the PTT terminal may directly collect the voice information of the user. It may also be that after the PTT terminal obtains the call right, the microphone device included in the call control apparatus collects the voice information of the user, and the call control apparatus sends the voice information to the PTT terminal through the communication module. If the microphone device included in the call control apparatus may synchronously broadcast the voice information received by the PTT terminal from the system during communication between the call control apparatus and the PTT terminal, the voice information from the system may be sent by another PTT terminal.

The call control apparatus provided by the embodiment of the present utility model may be designed into different shapes according to specific scenarios. For example, the call control apparatus is designed into a circular shape and is installed on a steering wheel of a car.

FIG. 2 is a schematic structural diagram of a PTT terminal according to an embodiment of the present utility model, where the PTT terminal includes: a communication module 21 and a control module 22, where

the communication module 21 is configured to communicate with a call control apparatus, and receive an instruction for obtaining or releasing a call right, where the instruction for obtaining or releasing a call right is sent by the call control apparatus; and

the control module 22 is configured to obtain a call right from a server or release a call right to a server according to the instruction for obtaining or releasing a call right, where the instruction for obtaining or releasing a call right is received by the communication module.

The PTT terminal provided by the embodiment of the present utility model establishes a communication connection with the call control apparatus through the communication module, and obtains the call right from the server or releases the call right to the server according to a notification sent by the call control apparatus, which facilities call control performed by a user on the PTT terminal.

Further, the communication module 21 may be, but not limited to, a Bluetooth device and is configured to communicate with the call control apparatus through Bluetooth. In addition, the PTT terminal provided by the embodiment of the present utility model includes, but is not limited to, a mobile phone having a PTT function.

FIG. 3 is a schematic structural diagram of a PTT call system according to an embodiment of the present utility model. The system includes a call control apparatus 31 and a PTT terminal 32. Modules included in the call control apparatus 31 and specific functions of the modules are the same as those in the call control apparatus provided by the foregoing embodiment of the present utility model, to which reference may be made. Modules included in the PTT terminal 32 and specific functions of the modules are the same as those in the PTT terminal provided by the foregoing embodiment of the present utility model, to which reference maybe made.

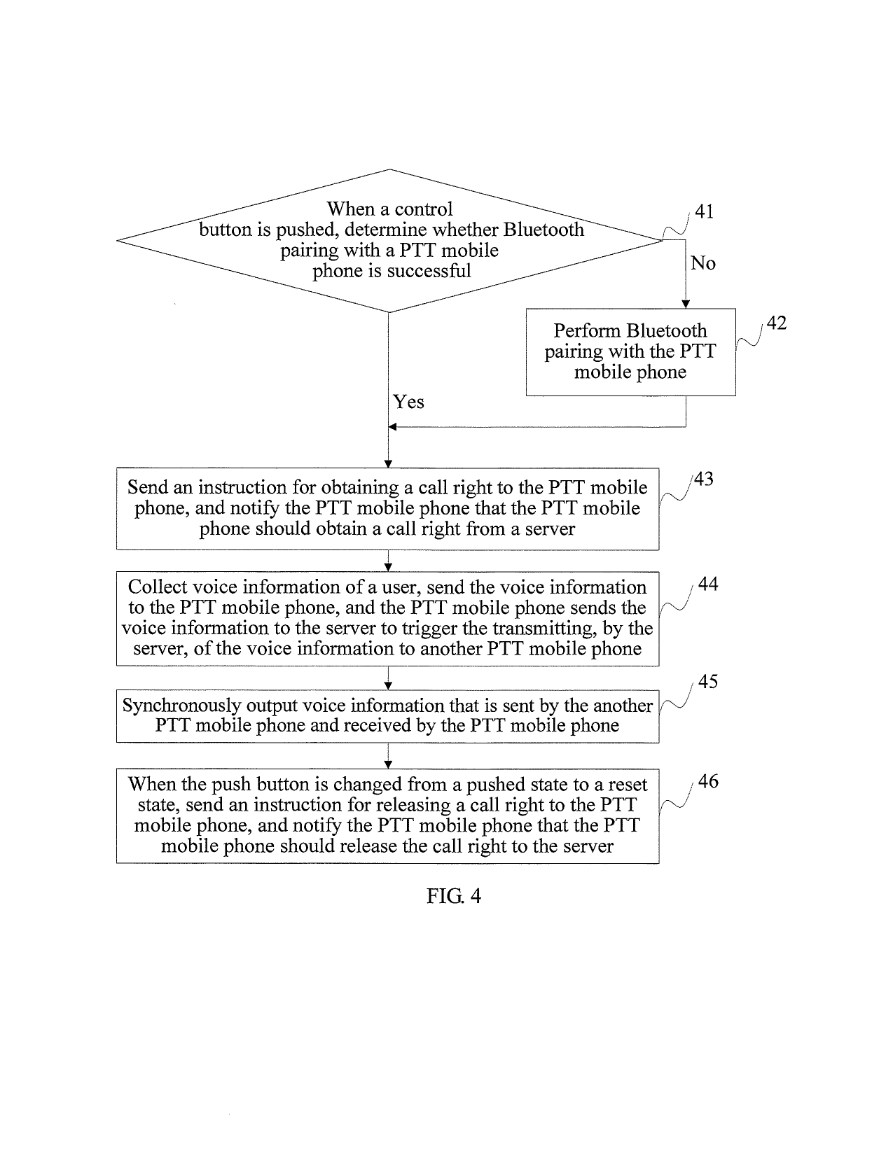

It is taken as an example in the following that a PTT terminal is a PTT mobile phone and a communication module is a Bluetooth device to introduce in detail an implementation process in which a call control apparatus controls the PTT mobile phone to obtain a call right from a server and release a call right to a server. FIG. 4 is a schematic flow chart showing that a call control apparatus controls a PTT mobile phone to obtain a call right from a server and release a call right to a server, which includes:

41: When a control button is pushed, determine whether Bluetooth pairing with the PTT mobile phone is successful.

If the Bluetooth pairing with the PTT mobile phone is successful, perform 43, and if the Bluetooth pairing with the PTT mobile phone is not successful, perform 42.

42: Perform Bluetooth pairing with the PTT mobile phone.

After the Bluetooth pairing with the PTT mobile phone is successfully performed, perform 43.

43: Send an instruction for obtaining a call right to the PTT mobile phone, and notify the PTT mobile phone that the PTT mobile phone should obtain a call right from a server.

44: Collect voice information of a user, send the voice information to the PTT mobile phone, and the PTT mobile phone sends the voice information to the server to trigger the transmitting, by the server, of the voice information to another PTT mobile phone.

It should be understood that if the PTT mobile phone has a strong capability of collecting voice information of a user, the PTT mobile phone may be used to directly collect the voice information of the user.

45: Synchronously output voice information that is sent by the another PTT mobile phone and received by the PTT mobile phone.

It should be understood that if the PTT mobile phone has a strong capability of outputting voice information, the PTT mobile phone may be used to directly output the received voice information sent by the another PTT mobile phone.

46: When the control button is changed from a pushed state to a reset state, send an instruction for releasing a call right to the PTT mobile phone, and notify the PTT mobile phone that the PTT mobile phone should release the call right to the server.

The call control apparatus may implement the steps shown in FIG. 4. The foregoing 41 to 46 are an exemplary implementation process, and in practice, a step may be deleted according to a specific scenario. For example, steps 41 and 42 are deleted, that is, when the control button is pushed, step 43 is directly performed. That is, Bluetooth pairing between the call control apparatus and the PTT mobile phone is successful by default, and when a disconnection occurs, the user is reminded to perform pairing again. In this way, the step of determining whether the Bluetooth pairing between the call control apparatus and the PTT mobile phone is successful is not required each time. A part of functions of the call control apparatus may be deleted, for example, the functions corresponding to the foregoing 44 and 45 are deleted. In practice, steps may be switched according to a specific scenario. For example, when the control button is pushed, the step of performing Bluetooth pairing between the call control apparatus and the PTT mobile phone is performed, and then it is determined whether the Bluetooth pairing between the call control apparatus and the PTT mobile phone is successful. If the Bluetooth pairing between the call control apparatus and the PTT mobile phone is successful, step 43 and subsequent steps are performed. A specific implementation manner is not specifically limited by the embodiment of the present utility model.

Therefore, after establishing a Bluetooth connection with the PTT mobile phone, the call control apparatus sends the instruction for obtaining or releasing a call right to the PTT mobile phone, and notifies the PTT mobile phone that the PTT mobile phone should obtain the call right from the server or release the call right to the server, which can further facilitate call control performed by the user on the PTT mobile phone.

It should be noted that when the call control apparatus provided by the embodiment of the present utility model controls the PTT terminal to obtain or release the call right, examples are provided for description based on dividing of the foregoing functional modules. In actual application, the foregoing functions may be assigned to different functional modules for completion as required. That is, an internal structure of the call control apparatus is divided into different functional modules to complete all or a part of the functions described in the foregoing.

The serial numbers of the foregoing embodiments of the present invention are only used for description, but do not indicate preference of the embodiments.

The foregoing embodiments are merely exemplary embodiments of the present utility model, but are not intended to limit the present utility model. Any modification, equivalent replacement, or improvement made within the principle of the present utility model should fall within the protection scope of the present utility model.

What is claimed is:

1. A call control apparatus, wherein the call control apparatus is configured to control a PTT terminal in a push to talk PTT call system to obtain or release a call right, the call control apparatus comprises: a control button, a processing chip, and a communication module, the control button is electrically connected to the processing chip, and the processing chip is electrically connected to the communication module, and wherein
the control button is configured to detect control information;
the processing chip is configured to generate, according to the control information that has been detected by the control button, an instruction for obtaining or releasing a call right, and send the instruction for obtaining or releasing a call right to the communication module; and
the communication module is configured to establish a communication connection with the PTT terminal, and after establishing the communication connection with the PTT terminal, send the received instruction for obtaining or releasing a call right to the PTT terminal, thereby triggering the obtaining or releasing, by the PTT terminal, of a call right.

2. The call control apparatus according to claim 1, wherein the communication module is a Bluetooth device and is configured to communicate with the PTT terminal through Bluetooth.

3. The call control apparatus according to claim 1, wherein the control button is positioned on a shell of the call control apparatus and is configured to detect the control information according to a pushed state of the control button.

4. The call control apparatus according to claim 1, wherein the call control apparatus further comprises:
an indicator light, positioned on a shell of the call control apparatus, connected to the processing chip, and configured to display, according to a display instruction generated by the processing chip, whether the PTT terminal obtains the call right.

5. The call control apparatus according to claim 1, wherein the call control apparatus further comprises:
a power input interface, positioned on a shell of the call control apparatus and configured to receive external power supply; or
an internal power supply module, configured to provide electric energy.

6. The call control apparatus according to claim 1, wherein the call control apparatus further comprises:
a voice module, configured to collect voice information of a user, send the collected voice information to the PTT terminal through the communication module, and synchronously output voice information received by the PTT terminal from the system.

7. A PTT terminal, wherein the PTT terminal comprises: a communication module and a control module, and wherein
the communication module is configured to communicate with a call control apparatus, and receive an instruction for obtaining or releasing a call right, wherein the instruction for obtaining or releasing a call right is sent by the call control apparatus; and
the control module is configured to obtain a call right from a server or release a call right to a server according to the instruction for obtaining or releasing a call right, wherein the instruction for obtaining or releasing a call right is received by the communication module.

8. The PTT terminal according to claim 7, wherein the communication module is a Bluetooth device and is configured to communicate with the call control apparatus through Bluetooth.

9. A PTT call system, wherein the PTT call system comprises a call control apparatus and a PTT terminal, and wherein
the call control apparatus is configured to detect control information, and generate, according to the control information, an instruction for obtaining or releasing a call right, and send the instruction for obtaining or releasing a call right to the PTT terminal, thereby triggering the obtaining or releasing, by the PTT terminal, of a call right; and
the PTT terminal is configured to receive an instruction for obtaining or releasing a call right, and obtain a call right from a server or release a call right to a server according to the instruction for obtaining or releasing a call right.

10. The PTT call system according to claim 9, wherein the call control apparatus is configured to communicate with the PTT terminal through Bluetooth; and
the PTT terminal is configured to communicate with the call control apparatus through Bluetooth.
